(19) United States
(12) Patent Application Publication
(10) Pub. No.: US 2013/0330157 A1
(43) Pub. Date: Dec. 12, 2013

(54) LOW FLOOR CHASSIS CONVERSION METHOD AND APPARATUS

(71) Applicant: Dallas Smith Corporation, Greencastle, IN (US)

(72) Inventors: Stephen A. Asztalos, Angola, IN (US); Garrett J. Smith, Chicago, IL (US); Judson Smith, Greencastle, IN (US)

(73) Assignee: Dallas Smith Corporation, Greencastle, IN (US)

(21) Appl. No.: 13/899,144

(22) Filed: May 21, 2013

Related U.S. Application Data
(60) Provisional application No. 61/649,707, filed on May 21, 2012.

(51) Int. Cl. A61G 3/06; B60G 11/27

(52) U.S. Cl. CPC A61G 3/065; B60G 11/27
USPC 414/469; 280/124.162; 29/897.2

(57) ABSTRACT

Methods and apparatus for converting an OEM ladder frame chassis. Various embodiments include modifying the front and rear suspensions to allow increased lowering of the payload section and cab sections, and further to incorporate a payload section having a lowered floor.

### CROSS REFERENCE TO RELATED APPLICATION

This application claims the benefit of priority to U.S. Provisional Patent Application Ser. No. 61/649,707, filed May 21, 2012, incorporated herein by reference.

### FIELD OF THE INVENTION

Various embodiments of the present invention pertain to methods and apparatus for modifying an OEM vehicle chassis so as to lower the floor of the payload compartment, and in some embodiments to lower the floor of the payload compartment and further support it with one or more air springs in the suspension.

### BACKGROUND OF THE INVENTION

There is an increased need for vehicles that provide easier accessibility transportation to all persons, especially for passengers with disabilities, such as persons requiring the use of wheelchairs. However, it is relatively expensive to design and fabricate wheelchair-ready transit buses, especially considering that the commercial market for wheelchair-accessible transports is still relatively small. Therefore, it is increasingly important to be able to modify existing vehicles in a cost-effective manner so that wheelchair accessibility can be achieved within the financial constraints of the commercial market. However, existing vehicles (OEM vehicles) including bus and truck chassis often have frames and wheel suspensions that are adapted and configured for higher volume markets such as standard “high floor” school buses, transit shuttle buses and short haul trucks. For these existing vehicles to be commercially viable, they must have very high strength and high stiffness ladder frames that can easily accommodate a variety of different payloads. As such, these frames are typically fabricated from a high strength steel of substantial thickness and substantial cross sectional moment of inertia. Further, these ladder OEM ladder frames tend to be flat, such that the suspensions are attached beneath it, and the payload mounted on top of it. Further, the frames of such vehicles tend to be relatively high relative to the road surface.

In order to add wheelchair accessibility to such OEM chassis, some manufacturers resort to the use of expensive, heavy wheelchair lifts to provide wheelchair accessibility, as often seen with school and standard “high floor” transit shuttle buses. School buses, transit shuttle buses, and short haul trucks typically have simple ladder frames that include a pair of opposing channel members (fabricated by processes such as extrusion, forming by press, or stamping) that extend the entire length of the vehicle, and located above the rotational axes of the supporting wheels. In those applications in which the modified vehicle is intended to be used for everyday transport of persons such as at airports (where passengers must contend with luggage) and senior citizen homes (carrying persons of reduced mobility) the high floor of the payload section is often one to three tall steps upward from the road surface, even if the OEM suspension is brought down to its lowest possible height and resting on the suspension travel stops (such as the jounce stops). A significant barrier to the modification of such heavy duty, high profile, ladder frame chassis lies in the challenge that transforming such chassis to have low floors for easier passenger accessibility can result in significant compromises to vehicle handling, stiffness and strength, especially if the modifications are to be made cost effectively.

What is needed are conversion kits and methods that can economically and safely reduce the floor height of the passenger compartment so that it is readily accessible to all persons, especially those persons with reduced mobility. Various embodiments of the present invention provide this in novel and unobvious ways.

### SUMMARY OF THE INVENTION

Various aspects of the present invention pertain to methods and apparatus for modifying an OEM ladder frame-based chassis to accommodate easier passenger vehicle accessibility, with or without a wheelchair access device, and further to be compliant with ADA requirements.

One aspect of some embodiments pertains to methods and apparatus for modifying the main longitudinally-extending rails of a vehicle to include a drop-down midsection adapted and configured to accommodate the fore to aft length needed to internally locate a back-to-back pair of passengers that use wheelchairs.

Still further embodiments include the aspect of modifying the OEM stiffness of the front and rear suspensions, and still further the amount the suspensions can be compressed, to permit the vehicle frame to be temporarily lowered to a greater extent than what is available in the OEM chassis. In this more extreme lowered state the payload section of the chassis can be made available to passengers with only modest steps by the passengers, and to passengers needing wheelchair access with an ADA compliant 1:6 ramp ratio. Such suspension modifications can include the replacement of OEM suspension springs with longer travel and/or higher internal volume replacement air springs, the relocation of air springs to an outboard position permitting a higher range of travel, and/or the replacement of OEM mechanical springs (such as leaf, coil, or torsional varieties) with replacement mechanical springs that are less stiff.

One aspect of the present invention pertains to a method of modifying a chassis for a road vehicle. Some embodiments include providing an OEM ladder frame chassis having a pair of right and left substantially straight longitudinal channel members each having a forward end adapted and configured to suspend corresponding right and left front wheels from respective right and left OEM springs each spring having an OEM spring stiffness. Other embodiments include replacing each OEM spring with a corresponding replacement spring having a replacement spring stiffness less than the OEM spring stiffness. Yet other embodiments include lowering the front jounce limit for each front suspended wheel. Still other embodiments include suspending the right and left wheels with corresponding right and left air springs, each air spring acting in parallel with the corresponding right or left replacement spring.

Another aspect of the present invention pertains to a method of modifying a chassis for a road vehicle. Some embodiments include providing an OEM ladder frame chassis having a pair of right and left substantially straight longitudinal channel members each having a forward end adapted and configured to suspend corresponding right and left front wheels below the channel members and an aft end adapted and configured to suspend corresponding right and left rear wheels below the channel members. Other embodiments include removing the OEM midsection of each channel member and thereafter inserting into each channel member corresponding right or left dropped height midsections, each dropped height midsection having a top surface lower than the top surface of the corresponding OEM channel member, each dropped height midsection having a bottom surface lower than the bottom surface of the corresponding OEM channel member. Yet other embodiments include lowering the front jounce limit for each front suspended wheel. Still other embodiments include lowering the rear jounce limit for each rear suspended wheel.

Yet another aspect of the present invention pertains to a chassis for a road vehicle. Some embodiments include a rear axle for rotatably supporting a pair of right and left rear wheels about a centerline. Yet other embodiments include a ladder frame including a pair of substantially straight longitudinal members each extending above said rear axle and from in front of the rear axle to behind the rear axle and each on opposite right or left sides of the frame. Still other embodiments include a pair of axle trailing arms or support members each located on opposite right or left sides of the frame, each support member being located outboard of the corresponding right or left longitudinal member and extending above the rear axle, the rear end of each the support member including an air spring support located aft of the centerline and behind a respective rear wheel. Yet other embodiments include a pair of air springs each having a top and a bottom, each air spring being located outboard of the corresponding longitudinal member and behind a respective rear wheel and each reacting loads between the ladder frame and the bottom of the corresponding the air spring support.

Still another aspect of the present invention pertains to a method of modifying a chassis for a road vehicle. Some embodiments include providing an OEM ladder frame chassis having a pair of right and left substantially straight longitudinal channel members each extending aft from the cab of the vehicle to an aft end adapted and configured to suspend corresponding right and left rear wheels below the channel members, each rear wheel being biased to a position by a corresponding OEM rear air spring located underneath the corresponding channel member, each OEM rear air spring providing a predetermined biasing force at an OEM air pressure. Other embodiments include removing the OEM midsection of each channel member behind the cab and thereafter inserting into each channel member corresponding right or left dropped height midsections, each dropped height midsection having a top surface lower than the top surface of the corresponding OEM channel member, each dropped height midsection having a bottom surface lower than the bottom surface of the corresponding OEM channel member. Still other embodiments include removing the OEM rear air springs. Yet other embodiments include modifying the OEM right and left rear suspension to accept an air spring located outboard of the corresponding channel member. Still other embodiments include installing right and left replacement rear air springs in the respective right and left positions of the modified rear suspension, each replacement air spring providing the predetermined biasing force at an air pressure less than the OEM air pressure.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Further, some of the figures shown herein may have been created from scaled drawings or from photographs that are scalable. It is understood that such dimensions, or the relative scaling within a figure, are by way of example, and not to be construed as limiting.

FIG. 1 is a rear, right side, perspective photographic representation of a modified chassis according to one embodiment of the present invention, looking forward.

FIG. 2 is a front, right side perspective photographic representation of the apparatus of FIG. 1, looking aft.

FIG. 3 is a left side, top perspective view looking aft of a central portion of the apparatus of FIG. 1.

FIG. 4 is a right side perspective photographic representation looking aft of the apparatus of FIG. 1.

FIG. 5 is a top, right side perspective photographic representation of a central portion of the apparatus of FIG. 1, looking forward and left.

FIG. 6 is an enlarged photographic representation of a portion of the hardware shown in FIG. 5.

FIG. 7 is a top, right side view looking aft of a photographic representation of the rear suspension of the apparatus of FIG. 1.

FIG. 8 is an enlargement of a photographic representation of a portion of the apparatus of FIG. 7.

FIG. 9 is a photographic representation of a portion of the rear suspension of the apparatus of FIG. 1.

FIG. 10 is a right side perspective photographic representation looking left and forward of a portion of the rear suspension of the apparatus of FIG. 1.

FIG. 11 is a photographic representation of a view looking forward of the suspension of FIG. 10.

FIG. 12 is a right side, front perspective photographic representation looking left and aft of a portion of the front suspension of the vehicle of FIG. 1.

FIG. 13 is an enlarged photographic representation of a portion of the apparatus of FIG. 12.

FIG. 14A is a largely side view of a photographic representation of an OEM leaf spring for the front suspension of a vehicle.

FIG. 14B is a side schematic representation of the apparatus of FIG. 14A as installed on a vehicle.

FIG. 14C is a right side schematic representation looking left of a portion of the front suspension of a vehicle according to one embodiment of the present invention.

FIG. 15 is a right side, rear perspective photographic representation looking forward of a vehicle to be modified according to another embodiment of the present invention.

FIG. 16 is a top perspective photographic representation looking forward of the apparatus of FIG. 15.

FIG. 17 is a right side, front perspective photographic representation of the rear suspension of the apparatus of FIG. 15.

FIG. 18 is a photographic representation looking downward at the left side suspension of the vehicle of FIG. 15.

FIG. 19 is a side photographic representation looking forward and right at the rear suspension of FIG. 18.

### ELEMENT NUMBERING

The following is a list of element numbers and at least one noun used to describe that element. It is understood that none of the embodiments disclosed herein are limited to these nouns, and these element numbers can further include other words that would be understood by a person of ordinary skill reading and reviewing this disclosure in its entirety.

| | |
|---|---|
| 20 | Vehicle |
| 22 | cab |
| 23 | Front wheels |
| 24 | Payload section |
| 25 | Rear wheels |
| 26 | Wheelchair ramp |
| 28 | Fuel tank |
| 30 | Frame |
| 32 | Longitudinal channeled support member |
| 34 | Midsection |
| 34(b) | Lower elevation |
| 35 | Gusset |
| 36 | Aft section |
| 36(b) | Higher elevation |
| 37 | Fuel tank |
| 38 | Driveshaft |
| 39 | Exhaust system |
| 40 | Rear suspension |
| 42 | axle |
| 43 | Clamps |
| 44 | Leaf spring |
| 46 | Height sensor |
| 48 | Lateral frame member |
| 50 | Trailing arm (or support arm) |
| 51 | Pivot |
| 52 | Front section |
| 54 | Rear section |
| 56 | Air spring |
| 57 | Bottom support |
| 58 | Top support |
| 60 | Air system |
| 62 | Air compressor |
| 64 | Air tank |
| 65 | Purge tank |
| 66 | Heat exchanger |
| 68 | Dryer and dump valve |
| 70 | Front suspension |
| 71 | Shock absorber |
| 72 | Wheel support |
| 73 | Anti roll bar |
| 74 | Leaf spring assembly |
| 74(b) | Front attachment |
| 74(c) | Rear attachment |
| 74(d) | Clamp |
| 74(e) | Central attachment |
| 74(f) | Top leaf |
| 74(g) | Bottom leaf |
| 75 | Front axle |
| 76 | Air spring |
| 77 | Bottom support |
| 78 | Top support |

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “preferably,” refers to features and aspects that are present in at least one embodiment, but which are optional for some embodiments.

The use of an N-series prefix for an element number (NXX.XX) refers to an element that is the same as the non-prefixed element (XX.XX), except as shown and described. As an example, an element 1020.1 would be the same as element 20.1, except for those different features of element 1020.1 shown and described. Further, common elements and common features of related elements may be drawn in the same manner in different figures, and/or use the same symbology in different figures. As such, it is not necessary to describe the features of 1020.1 and 20.1 that are the same, since these common features are apparent to a person of ordinary skill in the related field of technology. Further, it is understood that the features 1020.1 and 20.1 may be backward compatible, such that a feature (NXX.XX) may include features compatible with other various embodiments (MXX.XX), as would be understood by those of ordinary skill in the art. This description convention also applies to the use of prime (′), double prime (″), and triple prime (′″) suffixed element numbers. Therefore, it is not necessary to describe the features of 20.1, 20.1′, 20.1″, and 20.1′″ that are the same, since these common features are apparent to persons of ordinary skill in the related field of technology.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise explicitly noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

One embodiment of the present invention pertains to a kit for modifying a truck chassis. The kit includes a pair of frame midsections, a wheelchair ramp, and a pair of suspension arms. The frame sections are adapted and configured to be placed in the middle of the vehicle's existing frame rails. Preferably, this replacement midsection provides a dropped configuration to the OEM longitudinal channels, such that the resulting integrated structure extends at an OEM height along a forward section (such as under the cab), then drops down to a lower height for easier vehicle passenger (ambulatory/non-ambulatory) access, and then jogs back up to the OEM height in front of, over, and aft of the rear axle. The passenger (ambulatory/non-ambulatory) ramp is adapted and configured to be attached to one of the replacement frame midsections. The suspension trailing arms (or support arms) are adapted and configured to support the chassis with corresponding suspension air springs.

In yet another embodiment, the present invention pertains to a replacement trailing arm for the rear suspension of an existing chassis. Each trailing arm includes a forward portion that is adapted and configured to pivotally connect to a portion of the frame. This forward portion is located between the outboard side of a frame rail and the inboard side of a rear tire. This forward portion extends aft over the top, or aft under the rear axle to an aft portion. The aft portion of the trailing arm extends past the rear of the rear tires, and in some embodiments past the rear of the rear wheels, and further jogs outboard. The aft end of the trailing arm includes a mounting location for a spring located aft of the rear wheel or aft of the rear tire. In one embodiment, the aft mount supports an air spring.

Yet another embodiment of the present invention pertains to the addition of an air supply system dedicated to a vehicle's suspension. In one embodiment, the air system includes a compressor, a heat exchanger, a dryer, a filter, valves, a reservoir, and a plurality of air springs. In some embodiments, the size of the air springs is selected such that their typical inflation pressure is a moderate or low pressure in terms of the capability of the air compressor, and in some embodiments the range of typical operation is less than about 70 psig.

Preferably, the air springs that replace any OEM suspension springs are selected to provide equivalent spring force at a lower pressure (or, a greater spring force than the OEM spring force at the same predetermined pressure). By operating with a larger spring and/or a lower pressure, it has been found that the time to fill the air spring (such as from a completely deflated position) can be substantially reduced, especially if the selected air compressor provides the required range of air spring operating pressures at a point on the compressor map where the relatively lower pressure permits relatively higher flow rate out of the compressor.

It has been found that some current OEM air spring suspensions utilize a relatively small, higher pressure compressor that can be mounted in the engine compartment and using higher pressure air from this underhood compressor with relatively smaller OEM air springs. Although such an OEM system can provide a smaller packaging for both the suspension and the compressor, the OEM systems nonetheless require relatively long fill times, especially if the air springs have been completely deflated so as to bring the frame down to its lowest OEM level.

Various embodiments of the present invention provide modification kits to an OEM chassis that include an air system adapted and configured to be mounted aft of the cab section, and not require any underhood components. Still further, some embodiments of the present invention include the use of a replacement air compressor having substantially higher volumetric flow rate at the levels of pressure needed by the replacement air springs to provide OEM-type air spring biasing forces between the frame and the suspension. Still further, the replacement air springs are selected to require a lower air pressure level to generate the OEM-type biasing forces than the OEM air springs would. In combination, the higher flowing replacement air compressor and lower pressure air springs result in a system in which the time to reinflate the replacement air springs of the modified vehicle to restore the modified vehicle back to a vehicle height suitable for driving is substantially less than the time required by fully deflated OEM air compressor. This reinflation time can be useful in those applications where the vehicle is routinely expected to lower (deflate) and rise (back to operating ride height) during trips such as the frequent stopping/deflating/reinflating actions of shuttle buses at airports.

Still further, the various air handling components of the kit should be adapted and configured to be compatible with the other low profile aspects of the kit. In some embodiments, the air system components are adapted and configured to be placed entirely aft of the cab (with the exception of any front air springs), and more preferably in alignment with the profile of the drop-down midsection. In still further consideration that the drop-down midsection will be temporarily brought very close to the road surface (such as when the vehicle is in a kneeling configuration with deflated air springs), the air handling components need to be of narrow enough cross section so that they can be protected by the bottom surface of the drop-down midsections. Still further, in some embodiments the heat exchanger includes a plurality of fins that span the length of a tubular section, thus providing a heat exchanger with a low profile that can be protected by the drop-down midsection channels. In some embodiments, this heat exchanger is placed proximate to, and inboard, of a vehicle frame rail.

Yet other embodiments of the present invention pertain to a kit for modifying the front suspension of a vehicle. In one embodiment, the kit includes a replacement spring for the vehicle's OEM front spring. The replacement spring is adapted and configured to have a lower spring constant than the OEM spring. The kit can include replacement coil springs or replacement leaf springs dependent upon the configuration of the OEM spring. When the leaf spring of the kit is installed, the overall stiffness of the modified vehicle front leaf spring is reduced from the OEM stiffness in some embodiments by using a replacement leaf spring that is a modification of an OEM spring and having at least one leaf with reduced span.

The kit preferably further includes an air spring for additionally supporting the front of the vehicle from the OEM front spindle or front axle, the combination of the kit air spring and the reduced-stiffness kit mechanical spring combining to provide an overall spring rate from the replacement kit that is substantially the same as the OEM spring rate. However, the kit replacement springs can sustain a greater amount of suspension compression to permit a lower kneeled height when the air springs are completely deflated. This greater amount of compression is not available in the OEM suspension, in which the OEM jounce stop limits the maximum compression, and further because the OEM spring can be so stiff as to not permit the total amount of compression. Preferably, the replacement spring and the air spring support the front wheel relative to the frame in parallel.

Yet other embodiments of the present invention pertain to a kit for modifying the front and rear suspensions of a vehicle, especially a vehicle such as an ambulance. The vehicle includes the addition of air springs at the front and rear, and further includes modifications of the OEM front and/or rear springs to have a reduced spring stiffness. In yet other embodiments the OEM suspensions are modified with a replacement suspension jounce stop that permits additional compression of the suspension. By doing this, the vehicle can be lowered (by a reduction in air pressure) to a height that is lower than what would otherwise be achievable with the OEM standard, higher stiffness springs. In still further embodiments, the vehicle can have the rear section lowered (by removal of air pressure) and the front section lifted (by introduction of higher pressure) such that the payload section tilts aft at a higher angle than what would be otherwise achievable with an unmodified OEM suspension. With such a higher degree of tilt, a patient on a stretcher can be more easily placed in the payload section by a medical professional.

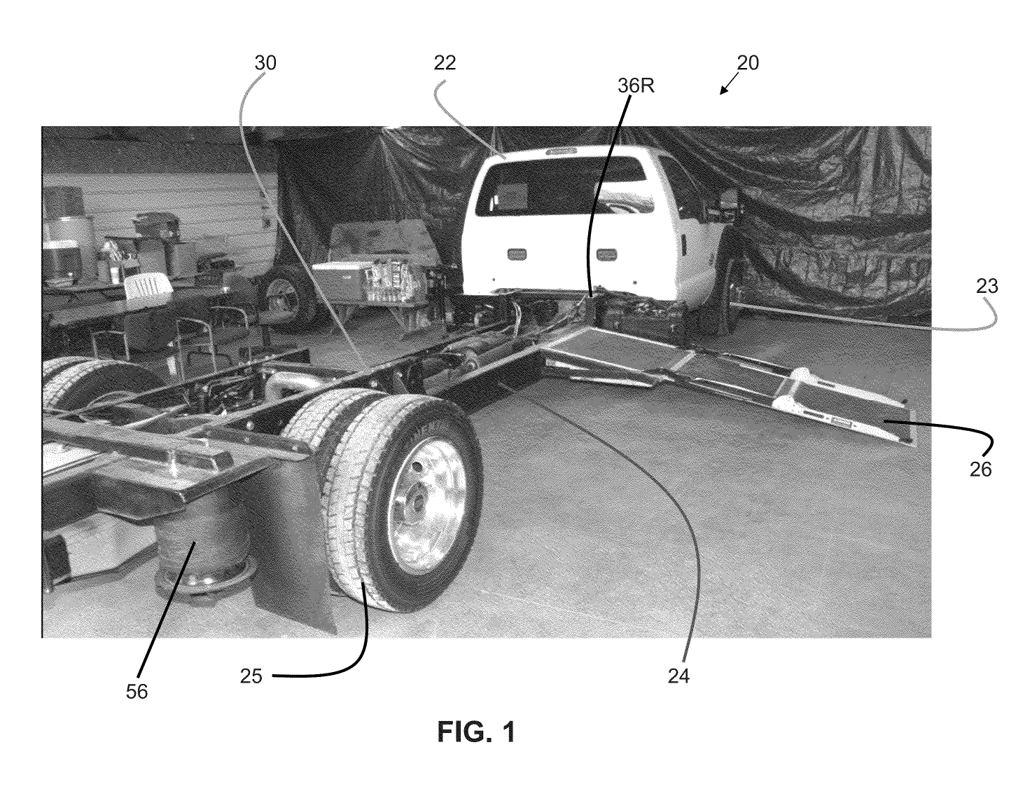

Referring to FIG. 1, a vehicle 20 according to one embodiment of the present invention is shown. In one embodiment, vehicle 20′ (the prime ′ superscript identifying an OEM configuration) is a Ford F550 cab and chassis. However, this identification of a particular manufacturer and model is by way of example only, and is not limiting on any embodiment of the present invention. As used herein, the suffixes “R” and “L” pertain to the right and left sides of the vehicle. Further, as is convention in this art, the terms fore and forward refer to a direction from the rear wheels toward the front wheels, and the terms inboard and outboard refer to the location of a component that is spaced either closer to the centerline or further from the centerline, respectively, of another feature

Vehicle 20 includes a cab section 22 with provisions for a driver, an engine, and steerable front wheels 23. A payload section 24 extends aft from cab section 22, including a frame 30 supported by a pair of rear wheels 25. The OEM frame includes right and left substantially straight longitudinal members that extend from the front wheels and under the cab to a location aft of the rear wheels. In some embodiments, the OEM channel members have a “C” cross section, although any configuration of OEM channel member is contemplated in various embodiments, including open-C channels, closed cross sectional channels, I cross sections, and other extruded and formed high stiffness configurations. In some embodiments, the OEM channel sections are typically of a “C” shape with the open side facing inboard. The height of the C channel is typically more than about six inches tall, and the material is typically more than about three-sixteenths inches thick. A typical material for the OEM rails is ASTM A36 steel. Various embodiments of the present invention pertain to the modification of an OEM chassis that is capable of operating with a gross vehicle weight requirement (GVWR) of more than ten-thousand pounds. Preferably, the right and left longitudinal OEM channels are substantially straight, and extend from aft to rear at locations over both the front rotational axis and the rear rotational axis.

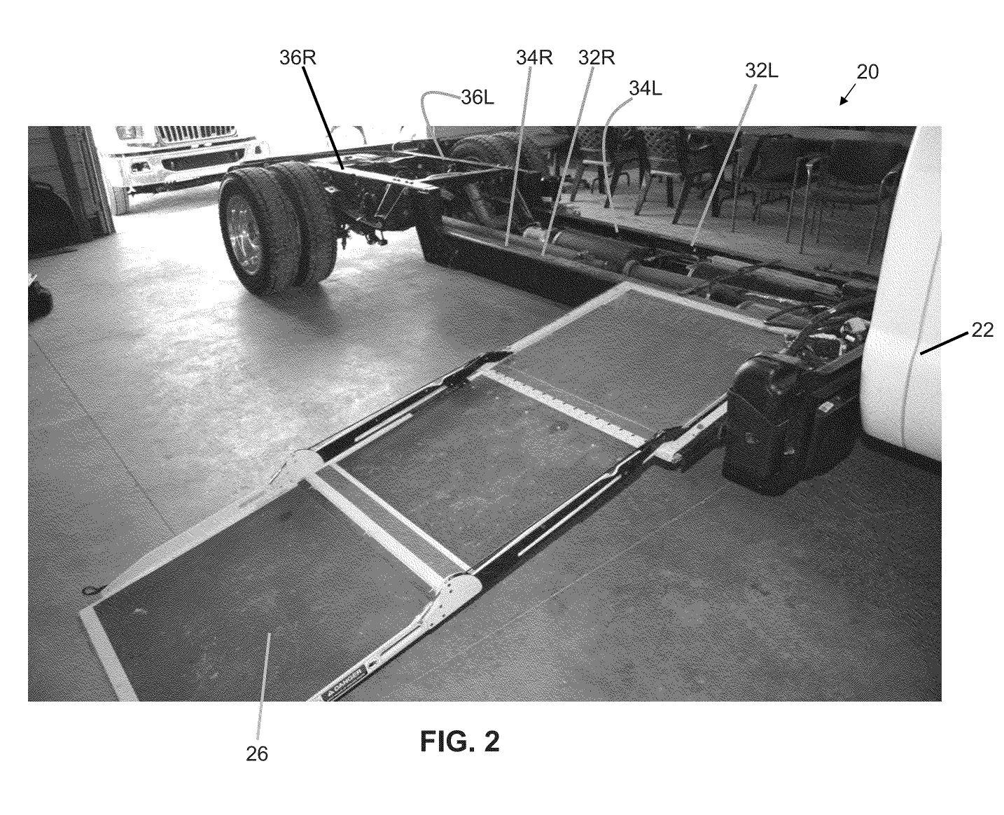

FIG. 2 shows the wheelchair ramp 26 fully deployed from the right side of payload section 24. Preferably, wheelchair ramp 26 is of the type that unfolds, although other embodiments contemplate the use of telescopic and/or elevator-type wheelchair assist mechanisms. Ramp 26 is coupled to a longitudinal support member 32R that extends along the right side of frame 30. Frame 30 includes a mirror image frame rail 32L extending aft from cab section 22 toward the rear of the vehicle. Although reference may be made to certain features in terms of the right or left sides of frame 30, it is understood that there is substantial symmetry between the right and left frame rails, and further that any of the other components placed relative to a frame rail could likewise be placed relative to the other frame rail.

FIG. 2 shows that longitudinal channel member 32R includes a midsection 34R and an aft section 36R. In one embodiment, frame section 36R is a remnant of the OEM channel frame member 36′ that extended substantially straight aft from cab 22. Frame midsection 34R is inserted into and replaces a section of OEM frame rail 36′R. It can be seen in FIG. 2 that frame section 34R jogs downwardly from a forward section 36R (as best seen in FIG. 1), extends aft in a low height midsection, and jogs upwardly to meet the rear remnant 36R of the frame rail. The lowered midsection 34 permits the use of a payload section 24 that has a floor lower and closer to the surface of the roadway than would be otherwise available in the OEM vehicle. As can be seen in FIG. 2, the top surface of the midsection is at a lower elevation than the top surface of the aft OEM channel, and the bottom surface of the replacement midsection is lower than the height of the lower surface of the aft OEM section.

FIG. 2 further shows that the fore to aft length of the dropped height midsection is substantially longer than the width of the wheelchair ramp 26. In some embodiments, the length of the replacement midsections are adapted and configured to support a payload section for passengers (not shown) that has sufficient length to internally support a pair of passengers and wheelchairs, one in front of the other. As shown in FIG. 2, the fore to aft span of the replacement midsection is more about twice the width of the wheelchair ramp 26.

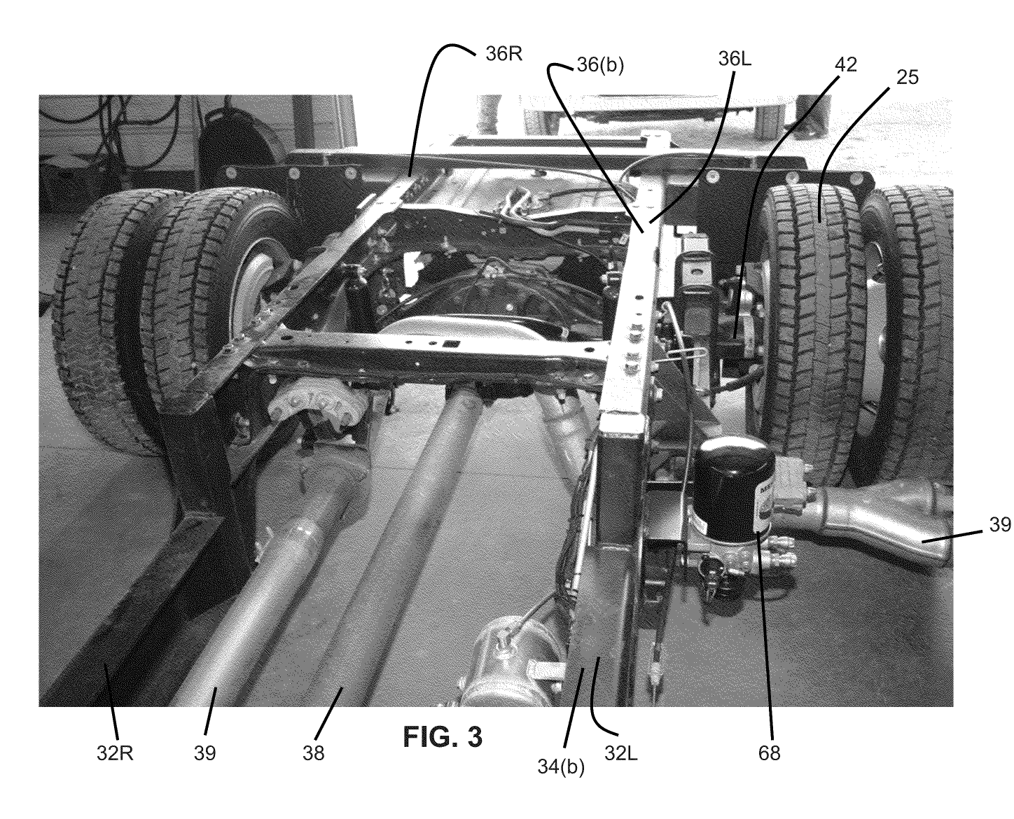

FIG. 3 shows the aft section of the chassis of vehicle 20. A pair of longitudinal support members extend aft. The midsection 34b of these frame members are at a lower height than the height 36b of the aft portion. The exhaust system 39 and drive shaft 38 are located in substantial part inboard of each longitudinal member 34. In some embodiments, the position of the drive shaft is lowered relative to the OEM position. A pair of rear wheels 25 are supported along a rear axle 42 and are located outboard support members 32. Each support member 32 includes a midsection 34 at a lowered height 34b, that jogs upward to an aft section 36 located at a higher elevation 36b.

In some embodiments, this placement of the wheel chair ramp permits a payload section to be adapted and configured for improved access by wheelchairs. As one example, the low height midsection 34 is adapted and configured such that the payload section on the side of the vehicle opposite the wheel chair ramp can accommodate two wheel chairs, and the side with the wheel chair ramp can accommodate a third wheel chair. These wheel chair locations of the payload section can further be adapted to include hinged seats when the spaces are not occupied with wheel chairs.

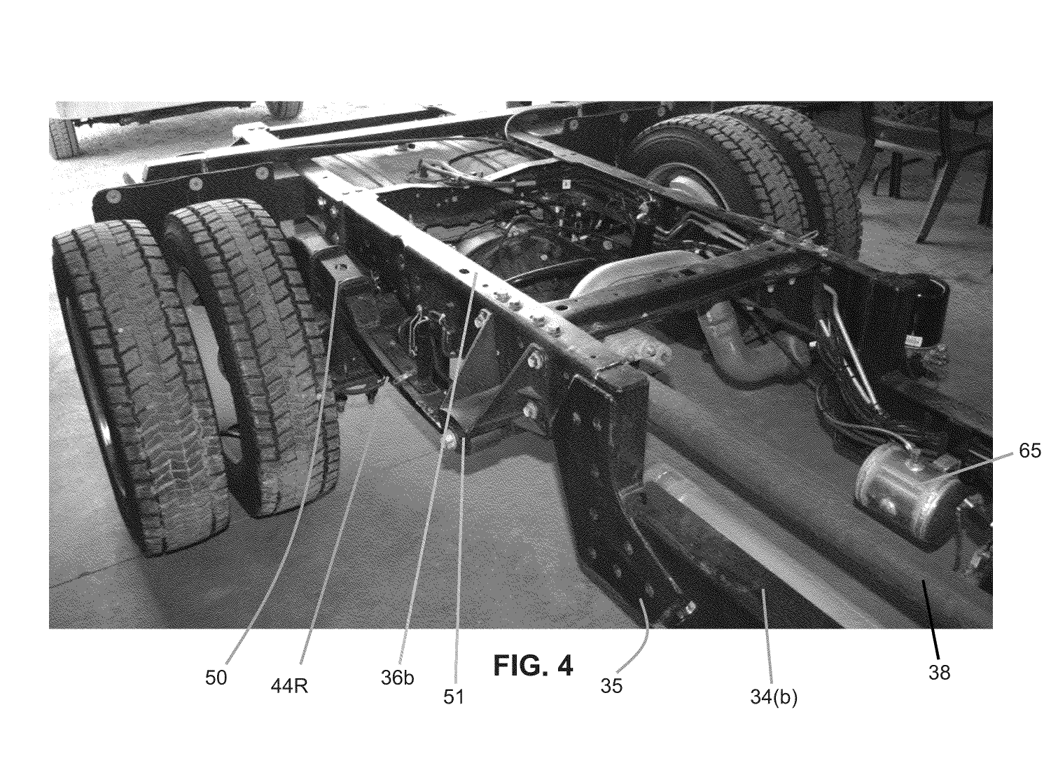

FIG. 4 shows additional details of vehicle 20. A strengthening gusset 35 couples the midsection 34 to the frame midsection 34 to the frame aft section 36. Each pair of rear wheels 25 is support by a trailing arm 50 that includes a front section 44 including a leaf spring. Preferably, the forward portion 44 of trailing arm 50 is coupled to a longitudinal support member by a pivot joint 51. In some embodiments, pivot joint 51 is preferably maintained at the same configuration as with the OEM vehicle, although other embodiments contemplate the use of other locations for coupling of the trailing arm pivot joint to the frame.

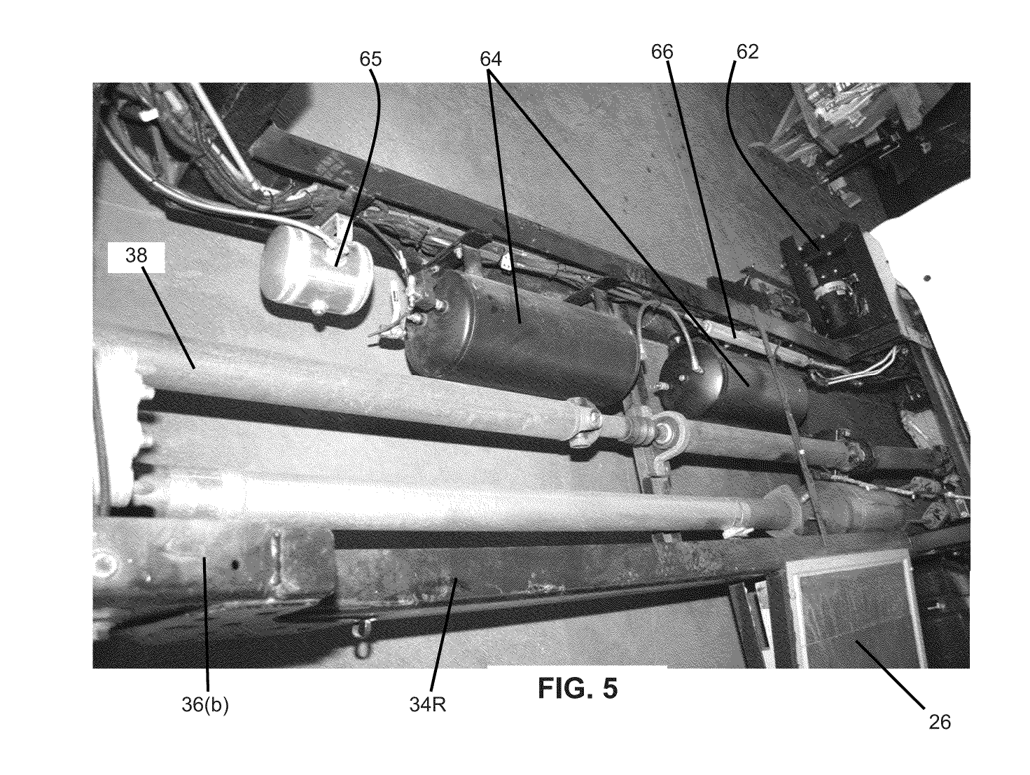

FIG. 5 shows a portion of the air system 60 of the vehicle 20. An air compressor 62 powered by an electric motor provides compressed ambient air to one or more air reservoirs 64. Some embodiments of the present invention place this compressor aft of the cab 22, especially when the cab 22 has insufficient under hood space for the addition of an engine-driven air compressor. Prior to storage in reservoirs 64, the compressed air is cooled in a heat exchanger 66. Compressed air from tanks 64 is provided through a dryer 68 (best seen in FIG. 3). A purge tank 65 provides a source of air to blow out dryer 68 after each usage of air system 60.

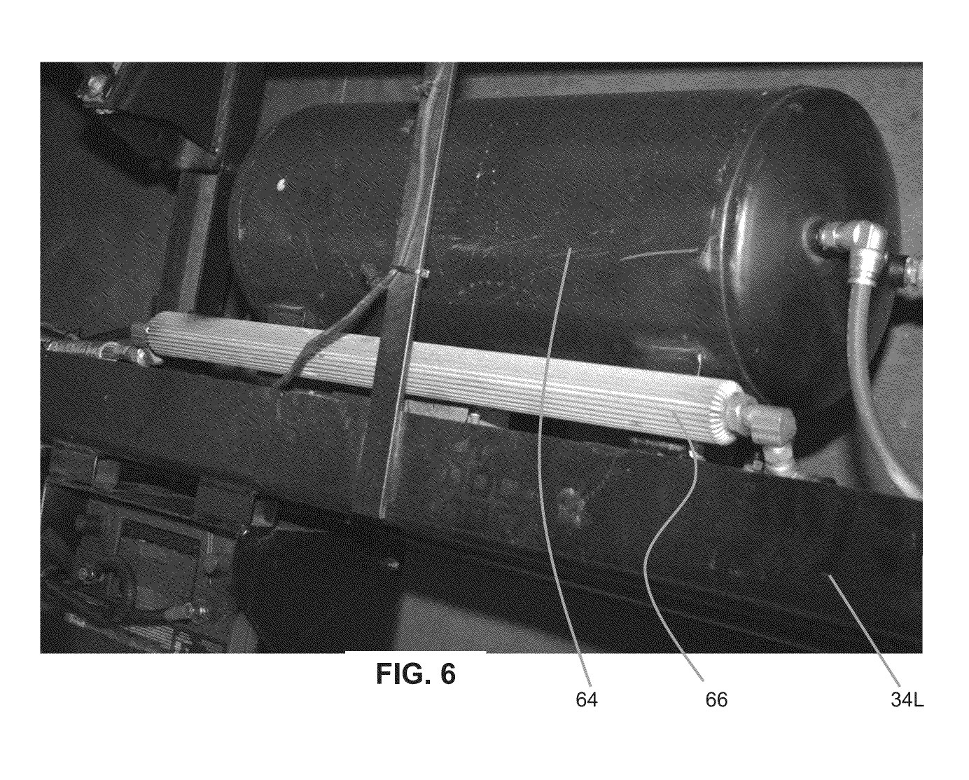

Referring to FIG. 6, one embodiment of heat exchanger 66 can be seen having a generally longitudinal configuration, with a plurality of radially extending fins to exchange heat with the ambient. In one embodiment, heat exchanger 66 is of the type that flows internally in a single direction (as seen in FIG. 6, from fore to aft). Heat exchanger 66 in some embodiments is particularly suited to packaging and placement under the payload section, and inboard of the frame midsections 34.

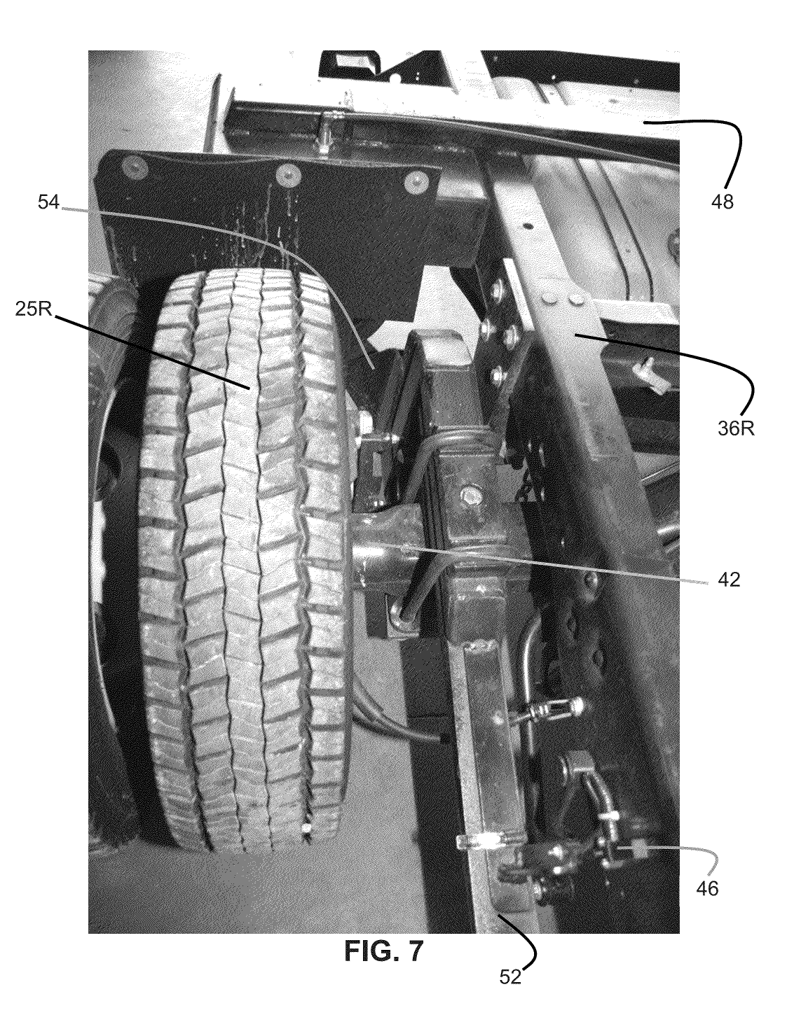

FIGS. 7-11 photographically show different views of the rear suspension of vehicle 20 according to one embodiment of the present invention. Wheels 25 are driven by an axle 42 that is powered by the engine through driveshaft 38. However, the present invention also contemplates those embodiments in which the rear wheels are not powered, and including those embodiments in which the vehicle front wheels are powered. The wheels 25 are coupled to frame 30 by right and left trailing arms 50. As best seen in FIG. 7, vehicle 20 preferably includes a height sensor 46, the signal of which is utilized by an onboard controller (not shown) to maintain a predetermined height of vehicle 20 by control of air pressure in the air springs.

Trailing arm 50 includes a forward section 52 that couples to the frame at a pivot joint 51. In some embodiments, the front section 52 includes one or more leaf springs for resilient support of the rear of vehicle 20. However, various other embodiments of the present invention include trailing arms 50 that have generally rigid front sections 52, but which pivotally couple to longitudinal member 36R. Still further embodiments contemplate trailing arms 50 that are coupled to longitudinal member 36R by way of one or more brackets, and using a resilient, elastomeric bushing as an interface member between the front end of the trailing arm and the bracket or channel member of the frame.

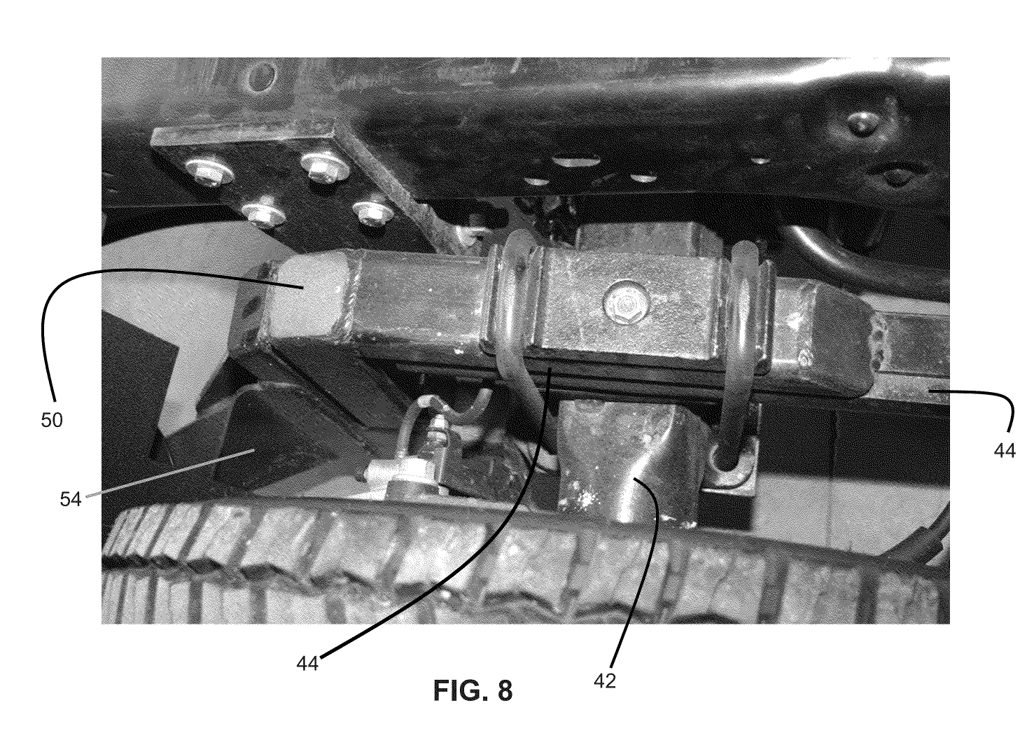

As best seen in FIGS. 4, 7, and 8, trailing arm 50 includes a lower front section 52 that, especially in those embodiments including a rear axle, extends aft and rises upward to pass over the axle. Referring to FIGS. 7 and 8, it can be seen that the midsection of trailing arm 50 is clamped to axle 42 by a pair of U-bolts. Further, as best seen in FIG. 8, the aft end of leaf springs 44 are coupled to axle 42 by these same U-bolts.

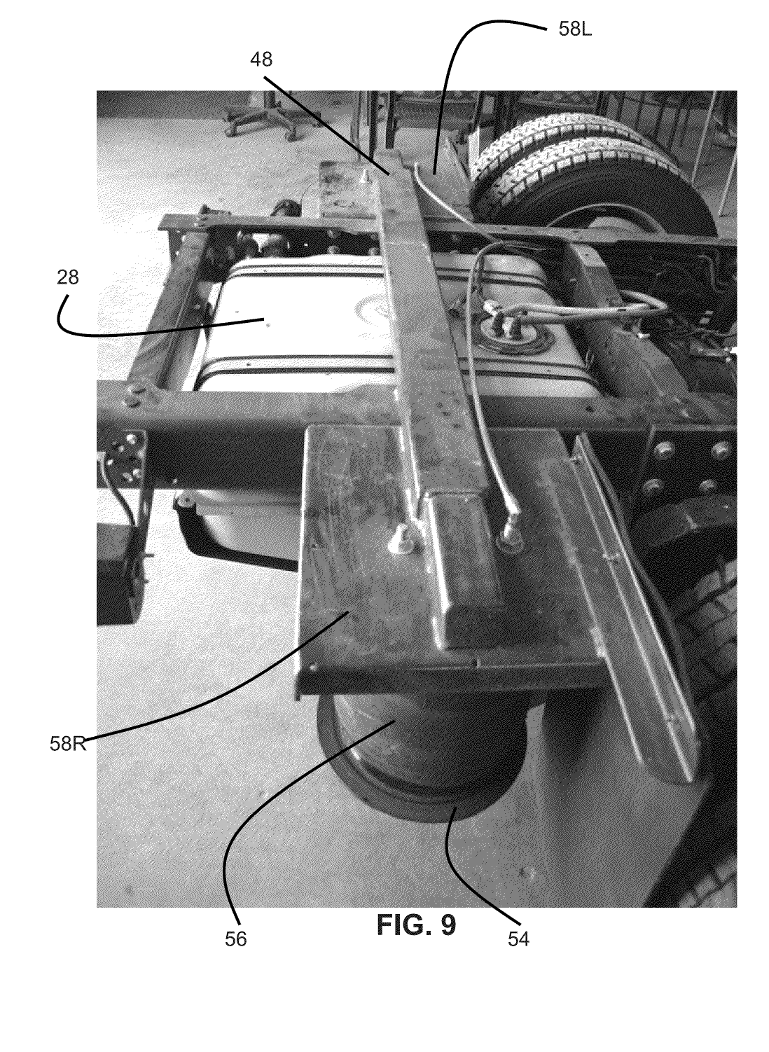

A rear section 54 of trailing arm 50 extends aft from the axle coupling in a substantially rigid section. As best seen in FIGS. 7, 8, and 11, this aft section extends downward, aft of the axle, and outboard, to a lower spring support 57. As best seen in FIG. 8, a central part of the aft section 54 extends both rearward and outboard such that at least a portion of spring support 57 is located behind one of the rear wheels 25. As best seen in FIGS. 9, 10, and 11, the spring support 57 of trailing arm 50 is further located lower than the central section of trailing arm 50 shown in FIG. 8. However, such geometry is by way of example only, and is not limiting on any embodiment of the present invention. As yet another example, in those embodiments in which the rear wheels are not driven, the central portion of the trailing arm may extend aft from the front portion of the trailing arm and connect in a more geometrically direct manner with the lower spring support.

The trailing arm 50 is adapted and configured in some embodiments to support an end of an air spring 56, the air spring itself supporting part of the vehicle weight from the suspension arm 50. Preferably, air spring 56 is of a lower pressure, larger diameter design, adapted and configured in accordance with the output characteristics of the air compressor so as to use an inflation pressure that is preferably toward the middle or lower region of the air compressor's pressure versus flow characteristics. In this manner, the compressor is able to provide substantially more flow at the lower inflation pressure than would be the case for an air spring of smaller diameter that requires higher pressure to support the vehicle. With such utilization of the higher flow characteristics of the compressor, it is possible to size the air springs and reservoirs for a quick refill after the vehicle has been lowered. In this manner, the quick refill permits a relatively quick overall cycle time for the vehicle (from the time the vehicle stops, lowers itself, raises itself, and continues traveling) this provides the unexpected benefit of more productive usage of the vehicle by lowering the typical air pressure within the air springs.

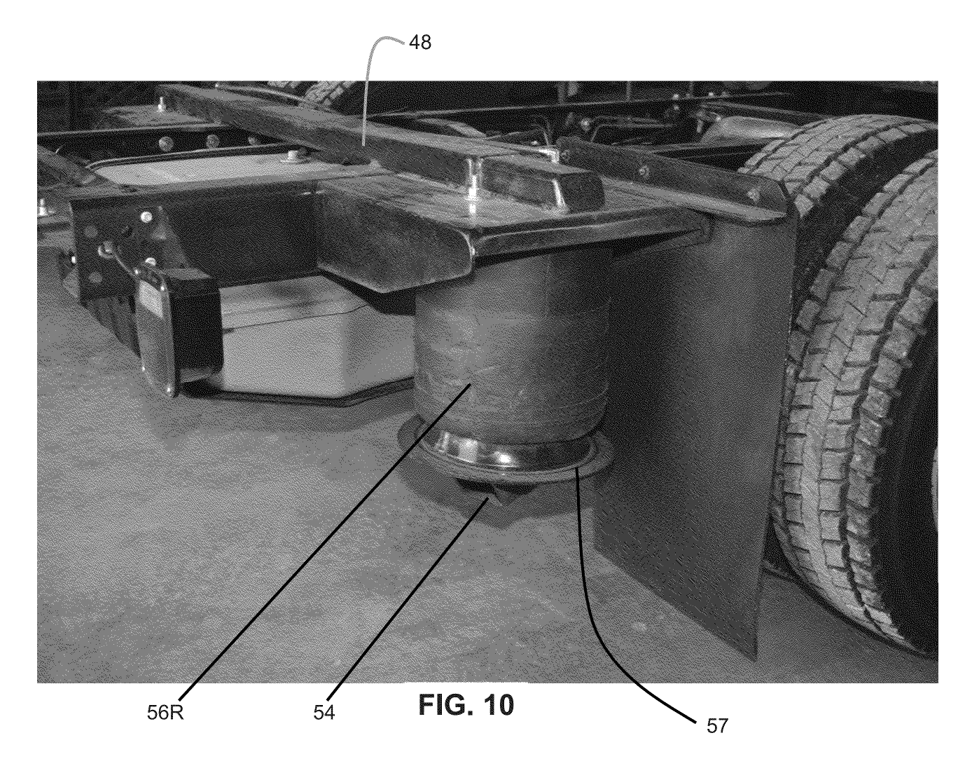

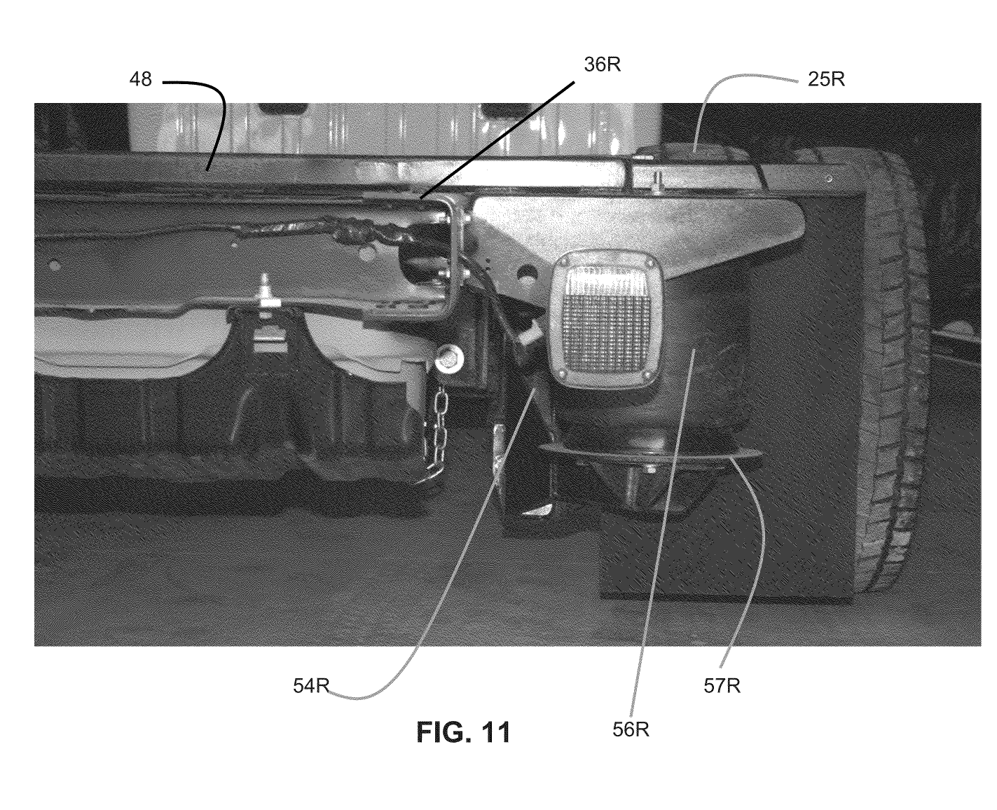

Vehicle 20 preferably includes a lateral frame member 48 that extends across the rear of the frame 30, as best seen in FIGS. 9 and 10. In some embodiments, this lateral member 48 extends across, and is coupled to, each aft section 36R and 36L of frame 30, such as by welding (although the present invention contemplates any manner of attachment). Preferably, lateral member 48 has a C-shaped or similar cross section for a combination of weight, stiffness, and drainage of water. As shown in FIG. 9, lateral member 48 is preferably unitary and coupled to both right and left side longitudinal channel members of the frame. In this manner, top spring supports 58R and 58L are provided with sufficient bending stiffness relative to the reaction loads imposed by air springs 56. FIG. 11 shows the bottom side of lateral member 48 welded to the top surface of C-channeled longitudinal member 36R. Further, FIG. 11 shows the location of air spring 56R behind the tire attached to rear wheel 25R.

Lateral member 48 supports at each end a top spring support 58. Top support 58L supports the top of air spring 56L. The top spring support 58R supports and provides mounting for the top air spring 56R. With placement of air springs 56 aft and behind rear wheels 25, and with the outboard spring support points provided by lateral frame member 48, the stability of vehicle 20 (especially in roll) is improved from that of the OEM vehicle. In some embodiments, a portion of the rear axle is coupled by a panhard rod to one of the longitudinal support members 32R or 32L for lateral stability of axle 42 relative to frame 30. In still further embodiments the modifications include the attachment of a sway bar to the differential of rear axle 42.

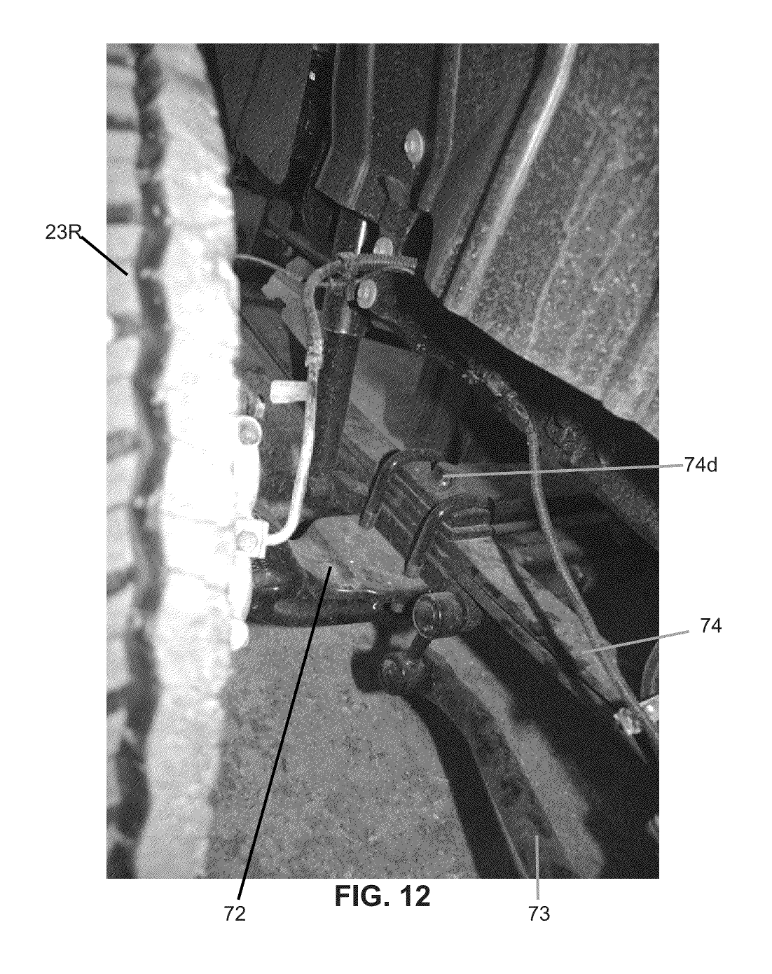

FIGS. 12, 13, and 14 show and describe various aspects of a front suspension 70 of vehicle 20. Vehicle 20 includes right and left wheels 23R and 23L, respectively, that support vehicle 20 from the roadway. Each wheel is coupled to a wheel support 72 attached by clamps 74(d) to a leaf spring assembly 74. A pair of shock absorbers 71 couple each wheel support 72 to the vehicle frame and dampen the movement of wheels 23. A roll bar 73 interconnects the right and left suspensions of vehicle 20 to improve the roll stability of the vehicle.

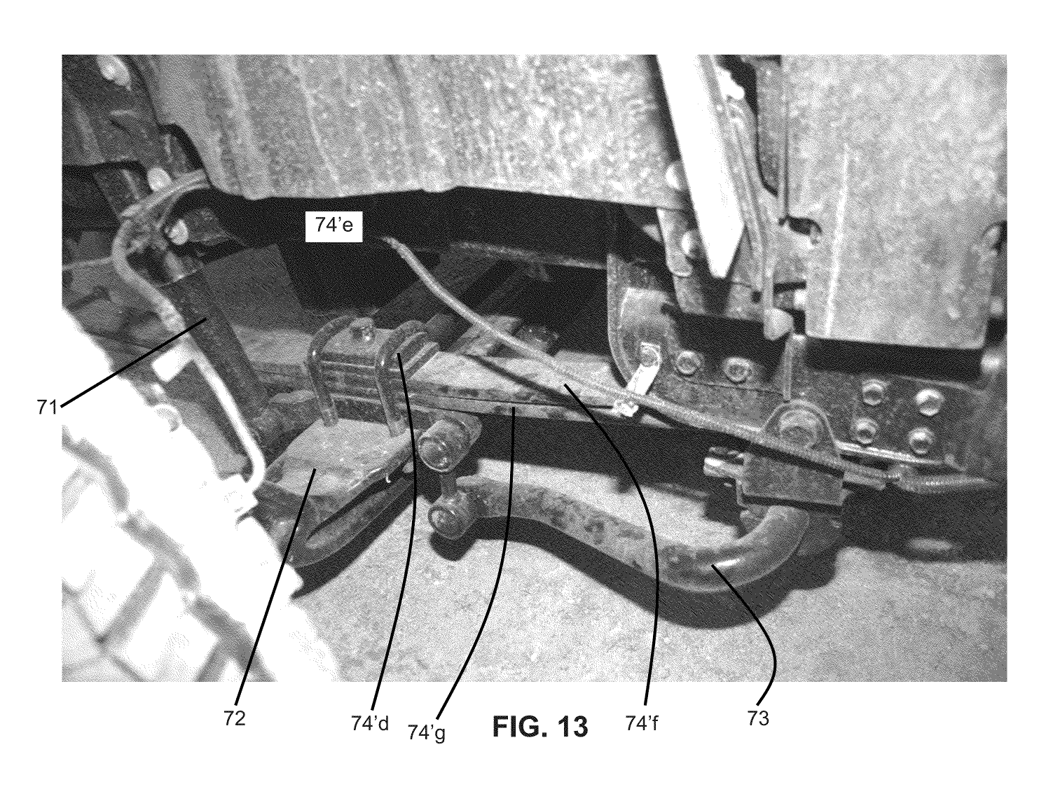

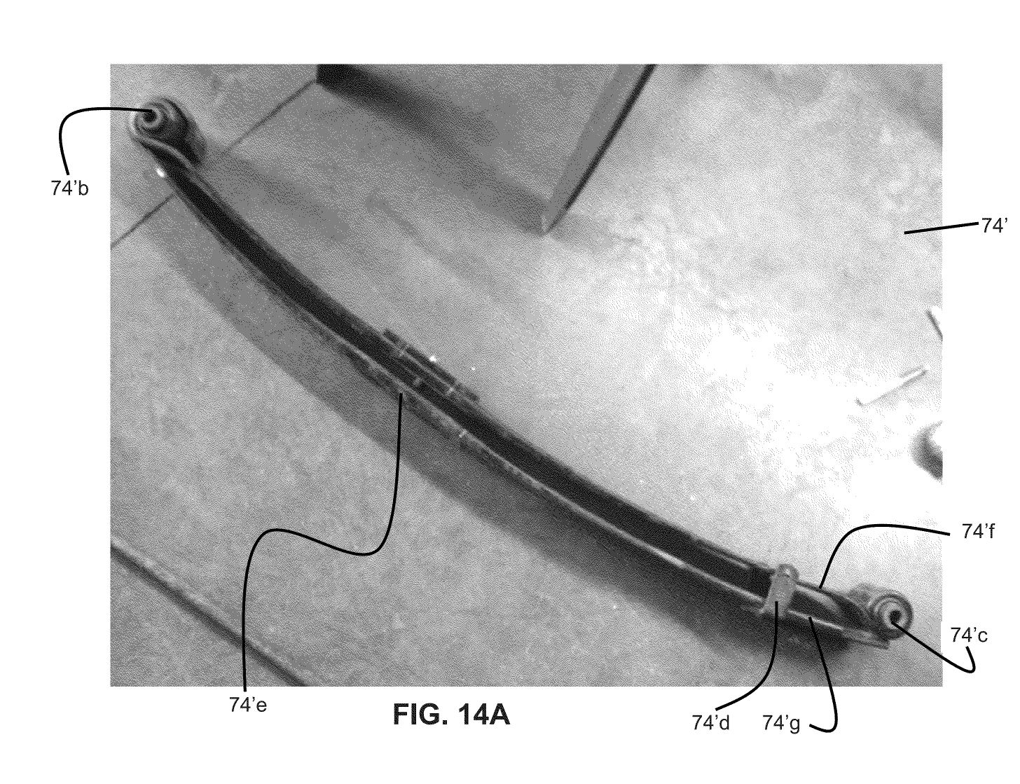

FIGS. 12, 13, 14A and 14B depict the leaf spring 74′ of the OEM vehicle. Leaf spring 74′ includes a top leaf spring 74′ and bottom leaf spring 74′g that extend from a foreword pivot joint 74′ be to an aft pivot joint 74′c. These top and bottom OEM leaf springs are coupled together by an aft clamp 74′ which is best seen in FIGS. 14A and 14B. Bottom OEM leaf spring 74′g is coupled to the front pivot joint 74′b and extends aft and is located underneath aft pivot joint 74′c. Referring to FIG. 14B, leaf spring assembly 74′ is coupled to front wheel support 72 by a central attachment 74′e. In one embodiment, this central attachment includes a pair of U-clamps and a centrally located fastener, as best seen in FIGS. 13 and 14B.

In one embodiment, the front suspension of vehicle 20 is modified to include an air spring support 76, and further to reduce the stiffness of the leaf spring 74′. FIG. 14C shows a right side front suspension according to one embodiment of the present invention. As shown in FIG. 14C, the bottom spring 74g in one embodiment of the present invention has a reduced length, and extends from the front pivot 74b to a point just aft of wheel support 72. Bottom leaf 74g is coupled to support 72 by the central attachment 74e. The aft section of OEM bottom leaf spring 74′ has been removed, which provides an overall reduced stiffness to leaf spring 74. However, in yet other embodiments a similar reduction in stiffness can be accomplished by using, as examples, a reduced thickness bottom leaf spring that extends from the front pivot to the aft pivot, or a bottom leaf of reduced width and commensurate reduced stiffness, or by eliminating the bottom spring altogether. In the latter case, the top leaf may be the OEM leaf, as one example, or could be a top leaf of increased stiffness, but yet in other embodiments could be a top leaf of reduced stiffness (as compared to the OEM top leaf). In those embodiments in which the springs of the front suspension are of the coil type, the OEM coils can be replaced with coils having reduced stiffness, such as by a reduction in wire diameter, change in the number of coils, change in the overall diameter of the spring, or other methods known for the reduction of coil spring stiffness.

Referring again to FIG. 14C, in some embodiments the front suspension of vehicle 20 includes a pair of air springs 76, one each for support of the right and left front suspension. The bottom of air spring 76 is preferably attached by a bottom support 77, which in some embodiments can also be the central attachment 74e which couples to suspension arm 72. However, in yet other embodiments, the air spring bottom and top supports 78, respectively, and air spring 76, are located outboard of the OEM attachment positions 74e, especially in those vehicles in which packaging constraints are best met with outboard placement of the air spring. However, the present invention contemplates any mounting of air spring 76.

Preferably, vehicle 20 includes a front section in which the OEM spring supports have reduced stiffness, and in which that stiffness is compensated by the introduction of the air support. In such embodiments, by reducing the internal pressure of the air support the vehicle can be brought to a lower position temporarily for ingress and egress of passengers from the payload section. This lower position is permitted by the reduced stiffness of the Front suspension springs 74. The continued use of modified front springs 74 in vehicle 20 allows for OEM-levels of reliability during operation.

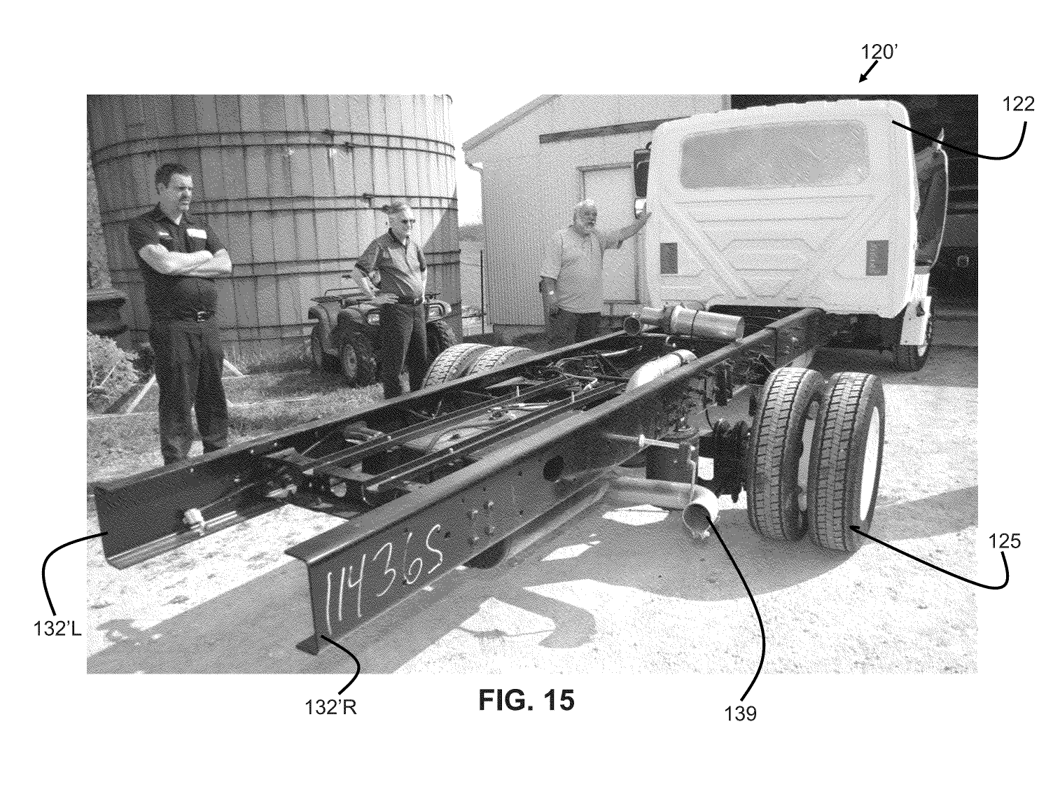

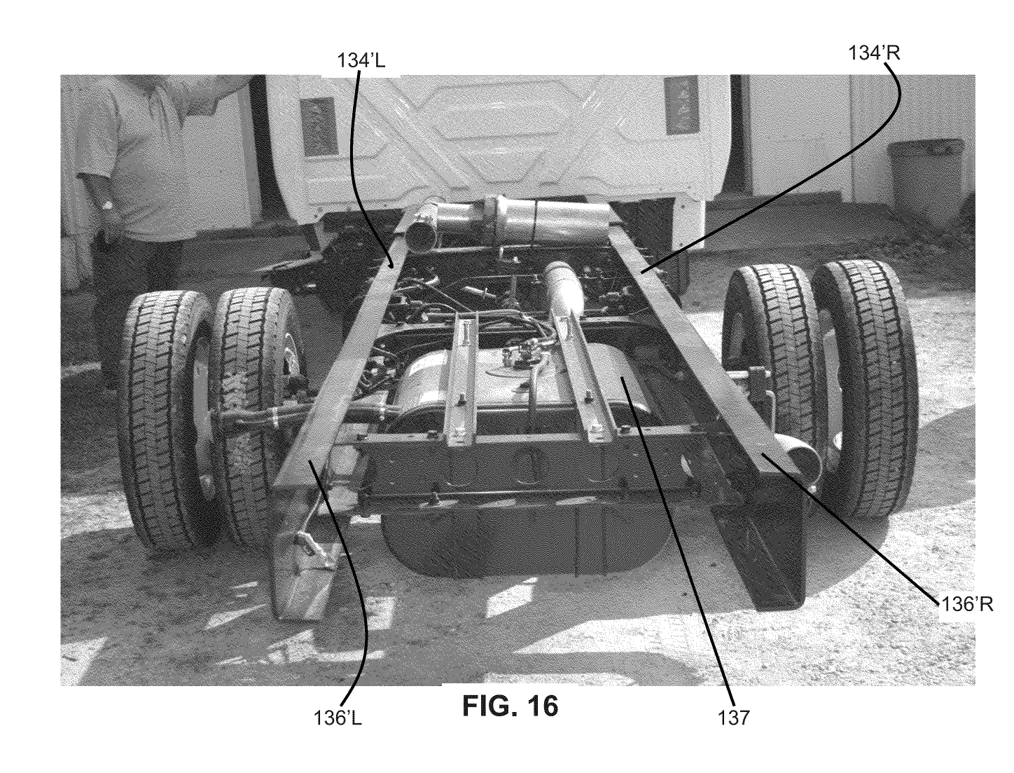

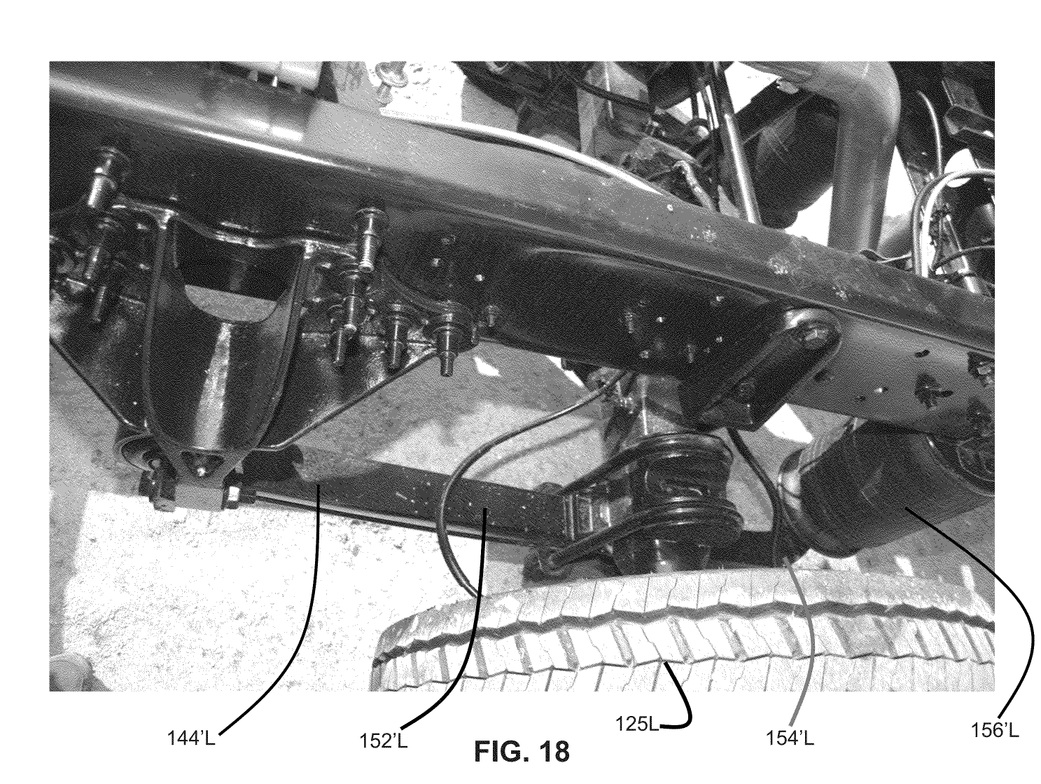

FIGS. 15, 16, 17, 18, and 19 show various aspects of a vehicle 120 according to another embodiment of the present invention. It is understood that the vehicle 120 depicted in these figures has not been modified to include the front suspension, rear suspension, air system, or midsection longitudinal support members as shown in the previous figures with regards to vehicle 20. However, these similar features, components, and aspects can also be incorporated into a modified vehicle 120. In one embodiment, vehicle 120 is based on a cab and chassis fabricated by manufacturer International Harvester. FIG. 16 shows the C-shaped cross sectional shape of the OEM longitudinal channel members, and their substantially straight and level top surfaces that extend fore and aft.

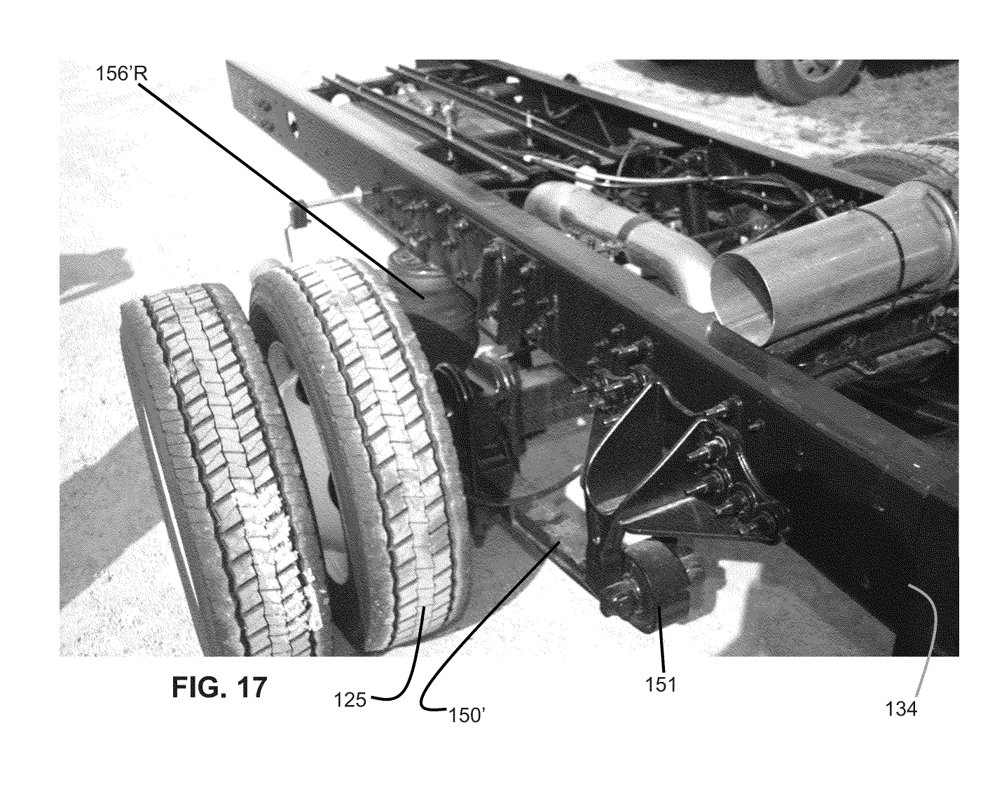

Vehicle 120 includes a pair of longitudinally-extending frame rails 132′L and 132′R that extend from 122 aft to the end of the vehicle. Rear wheels 125 are supported by trailing arms 150′ from corresponding frame rails. Referring to FIGS. 17, 18, 19, the rear suspension of vehicle 120 includes in its OEM state rear air springs 156′L and 156′R that coupled to the corresponding bottom spring supports 157′ of suspension arms 150′. Further, the forward sections 152′ incorporate leaf springs 144′ that are pivotally attached to a corresponding frame rail 132.

As modified, vehicle 120 includes a suspension trailing arm 150 with an aft portion 154 that extends laterally outboard from its OEM position. The corresponding air springs 156 are located aft and preferably behind rear wheels 125. A top spring support 158 (not shown) supports the top of air spring 156, and is further supported by frame 130 by a lateral frame member 148 (not shown). As previously discussed, the air springs 156 that are selected to replace the OEM air springs 156′ preferably provide a lower spring force at a predetermined pressure than the OEM springs provide at that same predetermined pressure. Still further, the replacement air springs 156 preferably provide a greater range of overall suspension travel than the OEM springs.

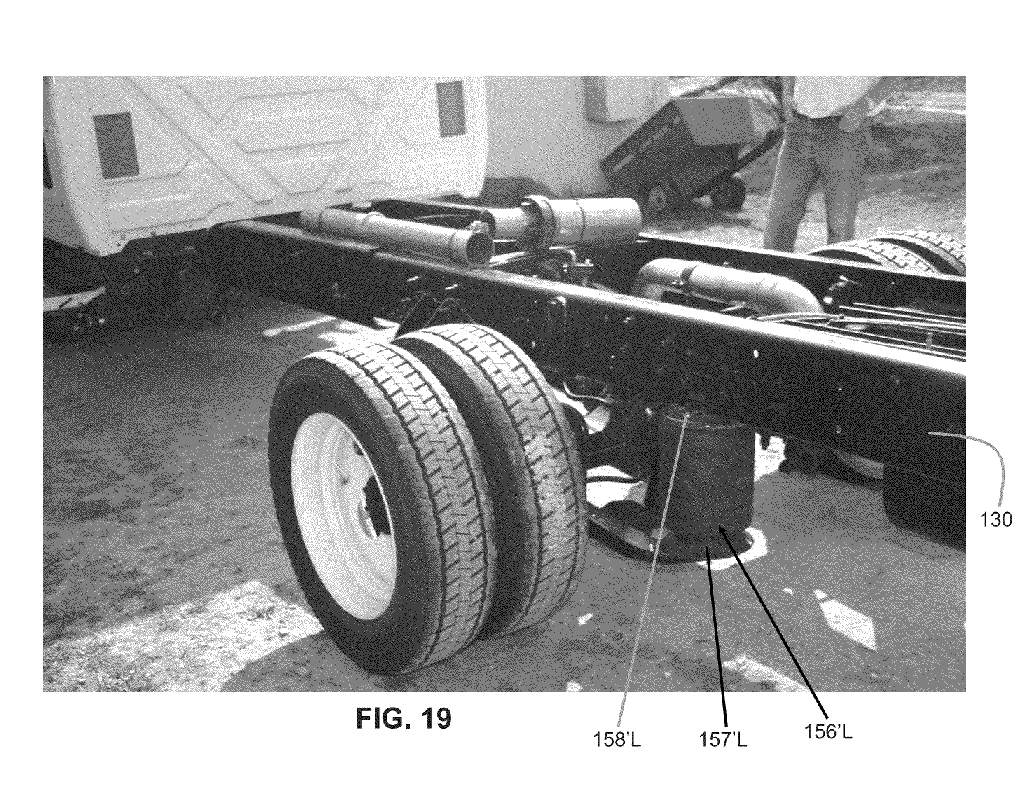

Comparing FIG. 16 to FIG. 10, it can be seen that the OEM spring in some embodiments is generally of a smaller diameter and smaller over height than the replacement air spring, such that the modified rear suspension is capable of greater travel (from bump stop to bump stop) than the OEM suspension. Comparing FIGS. 19 and 11, it can be seen that the top spring support is located at a higher position than the OEM top spring support, whereas the lower spring support 57R is at generally the same location (in some embodiments) as the lower spring support 157′L. By so changing the spring characteristics and further changing the location of the top spring mount, and especially in those embodiments combined with modified jounce stops, it is possible to compress the inventively modified rear suspension more than the OEM suspension, thus providing easier wheelchair access by having a lower overall modified vehicle. Still further, frame 130 is preferably modified in its midsection to include a lower elevation midsection 134 (not shown) that provides accommodation for a payload section 124 having a floor that is lower than what would be otherwise permitted by the OEM frame.

Various aspects of different embodiments of the present invention are expressed in paragraphs X1, X2, and X3 as follows:

X1. One aspect of the present invention pertains to a chassis for a road vehicle. The chassis preferably includes a rear axle for rotatably supporting a pair of right and left rear wheels about a centerline. The chassis preferably includes a ladder frame including a pair of substantially straight longitudinal members each extending above said rear axle and from in front of the rear axle to behind the rear axle and each on opposite right or left sides of said frame. The chassis preferably includes a pair of axle support members each located on opposite right or left sides of said frame, each said support member being located outboard of the corresponding said right or left longitudinal member and extending above said rear axle, the forward end of each said support member being coupled to said corresponding longitudinal member to permit vertical movement of said rear axle relative to said ladder frame, the rear end of each said support member including an air spring support located aft of the centerline and behind a respective said rear wheel. The chassis preferably includes a pair of air springs each having a top and a bottom, each said air spring being located outboard of said corresponding longitudinal member and behind a respective rear wheel and each reacting loads between said ladder frame and the bottom of the corresponding said air spring support.

X2. Another aspect of the present invention pertains to a method of modifying a chassis for a road vehicle. The method preferably includes providing an OEM ladder frame chassis having a pair of right and left substantially straight longitudinal channel members each having a forward end adapted and configured to suspend corresponding right and left front wheels from respective right and left OEM springs each spring having an OEM spring stiffness. The method preferably includes replacing each OEM spring with a corresponding replacement spring having a replacement spring stiffness less than the OEM spring stiffness. The method preferably includes lowering the front rebound limit for each front suspended wheel. The method preferably includes suspending the right and left wheels with corresponding right and left air springs, each air spring acting in parallel with the corresponding right or left replacement spring.

X3. Yet another aspect of the present invention pertains to a method of modifying a chassis for a road vehicle. The method preferably includes providing an OEM ladder frame chassis having a pair of right and left substantially straight longitudinal channel members each having a forward end adapted and configured to suspend corresponding right and left front wheels below the channel members and an aft end adapted and configured to suspend corresponding right and left rear wheels below the channel members, each rear wheel being driven by a driveshaft. The method preferably includes removing the OEM midsection of each channel member and thereafter inserting into each channel member corresponding right or left dropped height midsections, each dropped height midsection having a top surface lower than the top surface of the corresponding OEM channel member, each dropped height midsection having a bottom surface lower than the bottom surface of the corresponding OEM channel member. The method preferably includes lowering the driveshaft. The method preferably includes lowering the front rebound limit for each front suspended wheel. The method preferably includes lowering the rear rebound limit for each rear suspended wheel.

X4. Still another aspect of the present invention pertains to a method of modifying a chassis for a road vehicle. The method preferably includes providing an OEM ladder frame chassis having a pair of right and left substantially straight longitudinal channel members each extending aft from the cab of the vehicle to an aft end adapted and configured to suspend corresponding right and left rear wheels below the channel members, each rear wheel being biased to a position by a corresponding OEM rear air spring located underneath the corresponding channel member, each OEM rear air spring providing a predetermined biasing force at an OEM air pressure. The method preferably includes removing the OEM midsection of each channel member behind the cab and thereafter inserting into each channel member corresponding right or left dropped height midsections, each dropped height midsection having a top surface lower than the top surface of the corresponding OEM channel member, each dropped height midsection having a bottom surface lower than the bottom surface of the corresponding OEM channel member. The method preferably includes removing the OEM rear air springs. The method preferably includes modifying the OEM right and left rear suspension to accept an air spring located outboard of the corresponding channel member. The method preferably includes installing right and left replacement rear air springs in the respective right and left positions of the modified rear suspension, each replacement air spring providing the predetermined biasing force at an air pressure less than the OEM air pressure.

Yet other embodiments pertain to any of the previous statements X1, X2, X3, or X4 which are combined with one or more of the following other aspects:

Wherein each said support member includes a leaf spring having a forward end clamped with a bushing to said corresponding longitudinal member.

Wherein each said leaf spring having an aft end clamped to said corresponding air spring support, or wherein each said support member includes a leaf spring having an aft end clamped to said corresponding air spring support.

Wherein the forward end of each said support member is pivotally coupled to said corresponding longitudinal member, or herein each said support member includes a leaf spring having a forward end pivotally coupled to said corresponding longitudinal member.

Which further comprises a lateral member extending across the width of said ladder frame, said lateral member including right and left air spring platforms, each said platform providing a load path from the top of the corresponding said air spring to said ladder frame, said lateral member being located aft of the centerline.

Wherein said lateral member is attached to the top of each said longitudinal member.

Wherein said air spring supports are bottom air spring supports, and which further comprises a pair of top air spring supports, each said top air spring support extending laterally outboard of a corresponding said longitudinal member and providing a load path from the top of the corresponding said air spring to said longitudinal member, each said top air spring support being located aft of the centerline

Wherein said rear axle provides motive power to each said right and left wheels.

Which further comprises a wheel chair access platform, and wherein said ladder frame includes a midsection located forward of said right longitudinal member and adapted and configured for attachment to said platform.

Wherein said platform is a folding platform, or includes a laterally extending ramp, or includes a wheelchair lift.

Wherein said ladder frame includes a pair of midsections each located forward of said corresponding longitudinal member, each said longitudinal member having a top surface that is coplanar with the top surface of the other said longitudinal member, each said midsection having a top surface that is coplanar with the top surface of the other said midsection, and the top surface of said midsection is lower than the top surface of said longitudinal member.

Wherein each OEM spring is a leaf spring and each replacement spring is a leaf spring, or wherein each OEM spring is a leaf spring and each replacement spring is a modified OEM leaf spring, or wherein the OEM leaf spring has predetermined number of leaves, and the replacement leaf spring has at least one-half less leaf than the predetermined number.

Wherein each OEM spring is a coil spring and each replacement spring is a coil spring.

Wherein the OEM coil spring has predetermined number of coils and a predetermined wire diameter, and the replacement coil spring has at least one of fewer coils or a smaller wire diameter.

Wherein said providing includes OEM right and left front leaf springs suspending corresponding front wheels from the ladder frame, wherein said lowering the front jounce limit includes replacing each OEM leaf spring with a leaf spring having a reduced spring stiffness.

Which further comprises adding right and left front air springs each suspending the corresponding front wheel and acting in parallel with the corresponding reduced stiffness leaf spring.

Wherein said providing includes OEM right and left rear air spring mounts, wherein said lowering the rear jounce limit includes moving each rear air spring mount to a position outboard of the corresponding channel member.

Wherein said providing includes right and left OEM rear air springs each suspending a corresponding rear wheel from the ladder frame and each having an OEM spring force at a predetermined pressure, and which further comprises replacing each OEM rear air spring with corresponding replacement rear air springs each having a replacement spring force greater than the OEM spring force at the predetermined pressure.

Wherein said providing includes an OEM air compressor providing an OEM volumetric flowrate of compressed air at the OEM air pressure, and which further comprises installing a replacement air compressor providing a replacement volumetric flowrate at the OEM air pressure that is greater than the OEM volumetric flowrate.

Wherein said installing a replacement air compressor is behind the cab.

Which further comprises installing a compressed air heat exchanger proximate to a dropped height midsection at a location between the top and bottom surfaces.

Wherein the heat exchanger is a tube with a plurality of longitudinally arranged external fins.

Which further comprises lowering the rear jounce limit for each rear suspended wheel.

Wherein the OEM frame permits an OEM range of travel of the OEM air springs from typical operation to full compression when deflated, and which further comprises modifying the OEM ladder frame to permit a replacement range of travel of the replacement air springs from typical operation to full compression when deflated that is greater than the OEM range of travel.

Wherein said modifying the OEM ladder frame includes moving up and outboard the top of the rear air spring support.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method of modifying a chassis for a road vehicle, comprising:
providing an OEM ladder frame chassis having a pair of right and left substantially straight longitudinal channel members each having a forward end adapted and configured to suspend corresponding right and left front wheels from respective right and left OEM springs each spring having an OEM spring stiffness;
replacing each OEM spring with a corresponding replacement spring having a replacement spring stiffness less than the OEM spring stiffness;
lowering the front jounce limit for each front suspended wheel; and
suspending the right and left wheels with corresponding right and left air springs, each air spring acting in parallel with the corresponding right or left replacement spring.

2. The method of claim 1 wherein each OEM spring is a leaf spring and each replacement spring is a leaf spring.

3. The method of claim 1 wherein each OEM spring is a leaf spring and each replacement spring is a modified OEM leaf spring.

4. The method of claim 3 wherein the OEM leaf spring has predetermined number of leaves, and the replacement leaf spring has at least one-half less leaf than the predetermined number.

5. The method of claim 1 wherein each OEM spring is a coil spring and each replacement spring is a coil spring.

6. The method of claim 1 wherein the OEM coil spring has predetermined number of coils and a predetermined wire diameter, and the replacement coil spring has at least one of fewer coils or a smaller wire diameter.

7. A method of modifying a chassis for a road vehicle, comprising:
providing an OEM ladder frame chassis having a pair of right and left substantially straight longitudinal channel members each having a forward end adapted and configured to suspend corresponding right and left front wheels below the channel members and an aft end adapted and configured to suspend corresponding right and left rear wheels below the channel members, each rear wheel being driven by a driveshaft;
removing the OEM midsection of each channel member and thereafter inserting into each channel member corresponding right or left dropped height midsections, each dropped height midsection having a top surface lower than the top surface of the corresponding OEM channel member, each dropped height midsection having a bottom surface lower than the bottom surface of the corresponding OEM channel member;
lowering the driveshaft;
lowering the front jounce limit for each front suspended wheel; and
lowering the rear jounce limit for each rear suspended wheel.

8. The method of claim 7 wherein said providing includes OEM right and left rear air spring mounts, wherein said lowering the rear jounce limit includes moving each rear air spring mount to a position outboard of the corresponding channel member.

9. The method of claim 7 wherein said providing includes right and left OEM rear air springs each suspending a corresponding rear wheel from the ladder frame and each having an OEM spring force at a predetermined pressure, and which further comprises replacing each OEM rear air spring with corresponding replacement rear air springs each having a replacement spring force greater than the OEM spring force at the predetermined pressure.

10. The method of claim 7 wherein said providing includes OEM right and left front leaf springs suspending corresponding front wheels from the ladder frame, wherein said lowering the front jounce limit includes replacing each OEM leaf spring with a leaf spring having a reduced spring stiffness.

11. The method of claim 10 which further comprises adding right and left front air springs each suspending the corresponding front wheel and acting in parallel with the corresponding reduced stiffness leaf spring.

12. A chassis for a road vehicle, comprising:
a rear axle for rotatably supporting a pair of right and left rear wheels about a centerline;
a ladder frame including a pair of substantially straight longitudinal members each extending above said rear axle and from in front of the rear axle to behind the rear axle and each on opposite right or left sides of said frame;
a pair of axle support members each located on opposite right or left sides of said frame, each said support member being located outboard of the corresponding said right or left longitudinal member and extending above said rear axle, the forward end of each said support member being coupled to said corresponding longitudinal member to permit vertical movement of said rear axle relative to said ladder frame, the rear end of each said support member including an air spring support located aft of the centerline and behind a respective said rear wheel; and
a pair of air springs each having a top and a bottom, each said air spring being located outboard of said corresponding longitudinal member and behind a respective rear wheel and each reacting loads between said ladder frame and the bottom of the corresponding said air spring support.

13. The chassis of claim 12 which further comprises a lateral member extending across the width of said ladder frame, said lateral member including right and left air spring platforms, each said platform providing a load path from the top of the corresponding said air spring to said ladder frame, said lateral member being located aft of the centerline.

14. The chassis of claim 13 wherein said lateral member is attached to the top of each said longitudinal member.

15. The chassis of claim 12 wherein said air spring supports are bottom air spring supports, and which further comprises a pair of top air spring supports, each said top air spring support extending laterally outboard of a corresponding said longitudinal member and providing a load path from the top of the corresponding said air spring to said longitudinal member, each said top air spring support being located aft of the centerline.

16. The chassis of claim 12 wherein said rear axle provides motive power to each said right and left wheels.

17. The chassis of claim 12 which further comprises a wheel chair access platform, and wherein said ladder frame includes a midsection located forward of said right longitudinal member and adapted and configured for attachment to said platform.

18. The chassis of claim 17 wherein said platform is a folding platform.

19. The chassis of claim 17 wherein said platform includes a laterally extending ramp.

20. The chassis of claim 17 wherein said platform includes a wheel chair lift.

21. The chassis of claim 12 wherein said ladder frame includes a pair of midsections each located forward of said corresponding longitudinal member, each said longitudinal member having a top surface that is coplanar with the top surface of the other said longitudinal member, each said midsection having a top surface that is coplanar with the top surface of the other said midsection, and the top surface of said midsection is lower than the top surface of said longitudinal member.

22. The chassis of claim 12 wherein each said support member includes a leaf spring having a forward end clamped with a bushing to said corresponding longitudinal member.

23. The chassis of claim 22 wherein each said leaf spring having an aft end clamped to said corresponding air spring support.

24. The chassis of claim 12 wherein each said support member includes a leaf spring having an aft end clamped to said corresponding air spring support.

25. The chassis of claim 12 wherein the forward end of each said support member is pivotally coupled to said corresponding longitudinal member.

26. The chassis of claim 12 wherein each said support member includes a leaf spring having a forward end pivotally coupled to said corresponding longitudinal member.

27. A method of modifying a chassis for a road vehicle, comprising:
providing an OEM ladder frame chassis having a pair of right and left substantially straight longitudinal channel members each extending aft from the cab of the vehicle to an aft end adapted and configured to suspend corresponding right and left rear wheels below the channel members, each rear wheel being biased to a position by a corresponding OEM rear air spring located underneath the corresponding channel member, each OEM rear air spring providing a predetermined biasing force at an OEM air pressure;
removing the OEM midsection of each channel member behind the cab and thereafter inserting into each channel member corresponding right or left dropped height midsections, each dropped height midsection having a top surface lower than the top surface of the corresponding OEM channel member, each dropped height midsection having a bottom surface lower than the bottom surface of the corresponding OEM channel member;
removing the OEM rear air springs;
modifying the OEM right and left rear suspension to accept an air spring located outboard of the corresponding channel member; and
installing right and left replacement rear air springs in the respective right and left positions of the modified rear suspension, each replacement air spring providing the predetermined biasing force at an air pressure less than the OEM air pressure.

28. The method of claim 27 wherein said providing includes an OEM air compressor providing an OEM volumetric flowrate of compressed air at the OEM air pressure, and which further comprises installing a replacement air compressor providing a replacement volumetric flowrate at the OEM air pressure that is greater than the OEM volumetric flowrate.

29. The method of claim 28 wherein said installing a replacement air compressor is behind the cab.

30. The method of claim 27 which further comprises installing a compressed air heat exchanger proximate to a dropped height midsection at a location between the top and bottom surfaces.

31. The method of claim 30 wherein the heat exchanger is a tube with a plurality of longitudinally arranged external fins.

32. The method of claim 27 which further comprises lowering the rear jounce limit for each rear suspended wheel.

33. The method of claim 27 wherein the OEM frame permits an OEM range of travel of the OEM air springs from typical operation to full compression when deflated, and which further comprises modifying the OEM ladder frame to permit a replacement range of travel of the replacement air springs from typical operation to full compression when deflated that is greater than the OEM range of travel.

34. The method of claim 33 wherein said modifying the OEM ladder frame includes moving up and outboard the top of the rear air spring support.
